(19) United States
(12) Patent Application Publication
(10) Pub. No.: US 2023/0177523 A1
(43) Pub. Date: Jun. 8, 2023

(54) METHOD AND APPARATUS FOR CARBON EMISSION MANAGEMENT BASED ON DIGITAL TWIN

(71) Applicant: ELECTRONICS AND TELECOMMUNICATIONS RESEARCH INSTITUTE, Daejeon (KR)

(72) Inventors: Hyun Jeong LEE, Daejeon (KR); Chang Kyu LEE, Daejeon (KR); Yong Woon KIM, Daejeon (KR); Sang Keun YOO, Daejeon (KR)

(73) Assignee: ELECTRONICS AND TELECOMMUNICATIONS RESEARCH INSTITUTE, Daejeon (KR)

(21) Appl. No.: 18/073,070

(22) Filed: Dec. 1, 2022

(30) Foreign Application Priority Data
Dec. 7, 2021 (KR) 10-2021-0174207
Nov. 9, 2022 (KR) 10-2022-0148960

(51) Int. Cl. G06Q 30/018

(52) U.S. Cl. CPC G06Q 30/018

(57) ABSTRACT

The present disclosure relates to a method and an apparatus for a digital twin-based carbon emission management. A method according to an embodiment of the present disclosure may comprise: transmitting a request for information on a price of carbon emission credits; receiving a response including information on the price of the carbon emission credits; performing a simulation for carbon emission transaction and equipment operation based on the received price of the carbon emission credits and a digital twin for equipment operation; transmitting a request for carbon transaction according to the price of the carbon emission credits, based on a result of the simulation; and completing the carbon transaction by receiving a response to the request for the carbon transaction.

### CROSS-REFERENCE TO RELATED APPLICATIONS

This application claims the benefit of earlier filing date and right of priority to Korean Application No. 10-2021-0174207 filed on Dec. 7, 2021 and Korean Application No. 10-2022-0148960 filed on Nov. 9, 2022, the contents of which are all hereby incorporated by reference herein in their entirety.

### TECHNICAL FIELD

The present disclosure relates to carbon emission management, and specifically, to a method and apparatus for optimizing carbon emission management based on digital twin federation.

### BACKGROUND

As carbon emissions continue to increase due to industrialization, global warming and climate change are caused, resulting in damage. Accordingly, a policy related to carbon emission reduction has been implemented and strengthened at the global level.

Therefore, there is a need for a new system that continuously collects and manages urban and national carbon emission status, and optimizes on-site equipment operation while meeting carbon emission allowances for each operating entity and/or facility.

### SUMMARY

The technical object of the present disclosure is to provide a carbon emission management method and apparatus based on digital twin federation.

Another technical object of the present disclosure is to provide a method and apparatus for continuously managing total carbon emissions by continuously collecting and managing carbon emission information using a digital twin for each operating entity and/or facility. A digital twin is a concept that includes a digital twin system.

Another technical object of the present disclosure is to provide a method and apparatus for optimally managing on-site facility operation by simulating the carbon emission status and carbon emission transaction price for carbon emission reduction based on federating among digital twins.

A carbon emission management method based on a digital twin scheme according to an aspect of the present disclosure may comprise: transmitting a request for information on a price of carbon emission credits to a digital twin for carbon emission central control; receiving a response including information on the price of the carbon emission credits from the digital twin for the carbon emission central control; performing a simulation for carbon emission transaction and equipment operation based on the received price of the carbon emission credits and a digital twin for equipment operation; transmitting a request for carbon transaction according to the price of the carbon emission credits to the digital twin for the carbon emission central control, based on a result of the simulation; and completing the carbon transaction by receiving a response to the request for the carbon transaction from the digital twin for the carbon emission central control.

A carbon emission management apparatus based on a digital twin scheme according to an additional aspect of the present disclosure may comprise a processor, a transceiver and a memory for carbon emission management. The processor may comprise a first module to control management of carbon emission credit transaction and a second module to control execution of a simulation related to carbon emissions. The first module may control to: transmit a request for information on a price of carbon emission credits to a digital twin for carbon emission central control; and receive a response including information on the price of the carbon emission credits from the digital twin for the carbon emission central control. The second module may control to perform a simulation for carbon emissions transaction and equipment operation based on the received price of the carbon emission credits and a digital twin for equipment operation. The first module may further control to: transmit a request for carbon transaction according to the price of the carbon emission credits to the digital twin for the carbon emission central control, based on a result of the simulation; and receive a response to the request for the carbon transaction from the digital twin for the carbon emission central control. The carbon transaction may be completed based on the reception of the response to the request for the carbon transaction.

A carbon emission management method based on a digital twin scheme according to an additional aspect of the present disclosure may comprise: receiving a request for information on a price of carbon emission credits from a plurality of digital twins designed for each entity of equipment operation; performing a simulation to optimize the price of the carbon emission credits, based on a digital twin for carbon emission central control; transmitting a response including information on the price of the carbon emission credits to the plurality of digital twins, based on a result of the simulation; receiving a request for carbon transaction according to the price of the carbon emission credits from the plurality of digital twins; and completing the carbon transaction by transmitting a response to the request for the carbon transaction to the plurality of digital twins.

A carbon emission management apparatus based on a digital twin scheme according to an additional aspect of the present disclosure may comprise a processor, a transceiver and a memory for carbon emission management. The processor may comprise a first module to control management of carbon emission credit transaction and a second module to control execution of a simulation related to carbon emissions. The first module may control to receive a request for information on a price of carbon emission credits from a plurality of digital twins designed for each entity of equipment operation. The second module may control to perform a simulation to optimize the price of the carbon emission credits, based on a digital twin for carbon emission central control. The first module may further control to: transmit a response including information on the price of the carbon emission credits to the plurality of digital twins, based on a result of the simulation; receive a request for carbon transaction according to the price of the carbon emission credits from the plurality of digital twins; and transmit a response to the request for the carbon transaction to the plurality of digital twins. The carbon transaction may be completed based on the transmission of the response to the request for the carbon transaction.

In various aspects of the present disclosure, the method may further comprise: transmitting/receiving information for carbon emission allowances to/from the digital twin for carbon emission central control; and transmitting/receiving information on carbon emissions related to the equipment operation to/from the digital twin for the carbon emission central control.

In various aspects of the present disclosure, the method may further comprise receiving information requesting a reduction or adjustment of subsequent carbon emissions from the digital twin for carbon emission central control, when the carbon emissions related to the equipment operation exceeds the carbon emission allowances.

In various aspects of the present disclosure, the price of the carbon emission credits is determined through a simulation based on the carbon emission allowances and carbon emissions collected by a plurality of digital twins designed for each entity of equipment operation.

In various aspects of the present disclosure, the digital twin for the carbon emission central control includes a first digital twin for managing carbon emissions and a second digital twin for trading carbon emission credits. Alternatively, the digital twin for the carbon emission central control is a single digital twin designed by integrating a first digital twin for managing carbon emissions and a second digital twin for trading carbon emission credits.

The features briefly summarized above with respect to the present disclosure are merely exemplary aspects of the detailed description of the present disclosure that follows, and do not limit the scope of the present disclosure.

According to the present disclosure, a carbon emission management method and apparatus may be provided based on digital twin federation.

According to the present disclosure, a method and apparatus for continuously managing total carbon emission by continuously collecting and managing carbon emission information using a digital twin for each operating entity and/or facility may be provided.

According to the present disclosure, a method and apparatus for optimally managing on-site equipment operation by simulating the carbon emission status and carbon emission transaction price in order to meet the carbon emission allowances through the federation between the digital twins may be provided.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 is a diagram illustrating federation between digital twins according to an embodiment of the present disclosure.

FIG. 2 is a diagram illustrating an example of the configuration of the digital twin shown in FIG. 1.

FIG. 3 is a diagram illustrating federation between digital twins for carbon emission management according to an embodiment of the present disclosure.

FIG. 4 is a diagram illustrating a digital twin device according to an embodiment of the present disclosure.

### DETAILED DESCRIPTION

Hereinafter, embodiments of the present disclosure will be described in detail with reference to the accompanying drawings so that those of ordinary skill in the art to which the present disclosure pertains can easily implement them. However, the present disclosure may be embodied in several different forms and is not limited to the embodiments described herein.

In describing an embodiment of the present disclosure, if it is determined that a detailed description of a well-known configuration or function may obscure the gist of the present disclosure, a detailed description thereof will be omitted. And, in the drawings, parts not related to the description of the present disclosure are omitted, and similar reference numerals are attached to similar parts.

In the present disclosure, when an element is referred to as being “connected”, “combined” or “linked” to another element, it may include an indirect connection relation that yet another element presents therebetween as well as a direct connection relation. Also, when it is said that a component includes “includes” or “has” another component, it means that another component may be further included without excluding other components unless otherwise stated.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

In the present disclosure, the components that are distinguished from each other are for clearly explaining each characteristic, and do not necessarily mean that the components are separated. That is, a plurality of components may be integrated to form one hardware or software unit, or one component may be distributed to form a plurality of hardware or software units. Therefore, even if not separately mentioned, such integrated or distributed embodiments are also included in the scope of the present disclosure.

In the present disclosure, components described in various embodiments do not necessarily mean essential components, and some may be optional components. Accordingly, an embodiment composed of a subset of components described in an embodiment is also included in the scope of the present disclosure. In addition, embodiments including other components in addition to components described in various embodiments are also included in the scope of the present disclosure.

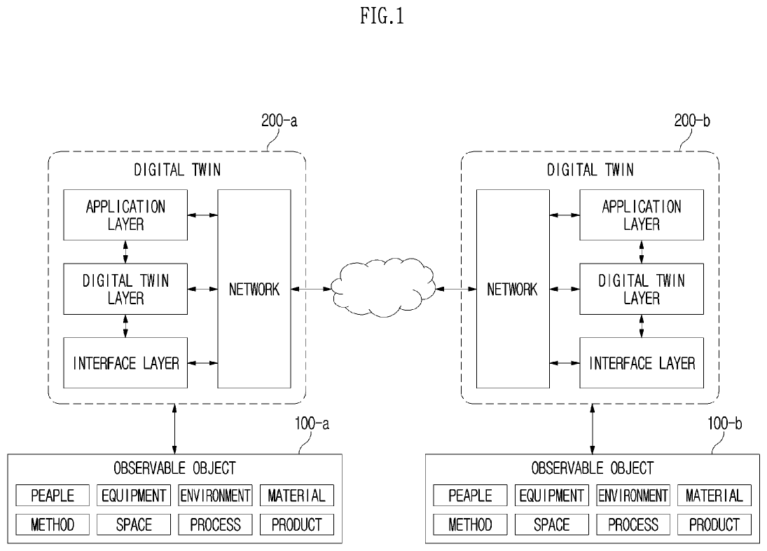

FIG. 1 is a diagram illustrating federation between digital twins according to an embodiment of the present disclosure.

Referring to FIG. 1, the digital twin 200 (eg, 200-a, 200-b) means that the expression of an observable object 100 (eg, 100-a, 100-b) of the corresponding domain is expressed as a virtual object on software, respectively. Here, the domain may be defined as an application domain such as manufacturing, city, home, energy, medical, transportation, environment, water supply field, etc., or may be defined according to the life cycle of the observable object 100, or may be subdivided and defined according to a physical and logical location, or may be subdivided and defined according to the role of the observable object 100.

For example, even in the manufacturing field, domains may be defined as shelf domains, conveyor transport domains, packaging domains, inventory management domains, etc., and have the same physical configuration, but in the case of three-shift production, it may be defined by dividing it into different domains according to time zones. In the case of conveyor transfer, it may be defined by dividing it into a conveyor roller domain, a conveyor motor domain, and a conveyor safety management domain.

For another example, in the environmental field, a domain may be defined as a carbon emission management domain, an industrial waste management domain, and the like.

As such, the meaning of the domain may be defined as different types of operation areas according to differences in purpose and function, and may be defined in various other ways.

The observable object 100 may include various observable objects such as people, equipment, environments, materials, methods, spaces, processes, products, documents, and the like, and all observable objects. For example, in relation to a digital twin for carbon emission management, the observable object 100 may include equipment existing in each operating entity and/or facility.

The above-described digital twin 200 may be composed of an interface layer, a digital twin layer, and an application layer.

Here, the interface layer may provide an interface for the digital twin to communicate and/or interact/operate with the corresponding observable object.

The digital twin layer may perform functions such as operation, management, and data synchronization based on domains in the digital twin. For example, in the case of a carbon emission management domain, the digital twin layer may perform a carbon emission collection and management function, a carbon emission-related simulation function, and a carbon emission credit transaction management function.

The application layer 230 may perform a past reproduction function, a current monitoring function, a future prediction function, a decision-making function, and the like.

As shown in FIG. 1, these digital twins 200-a and 200-b may be connected to each other through a network.

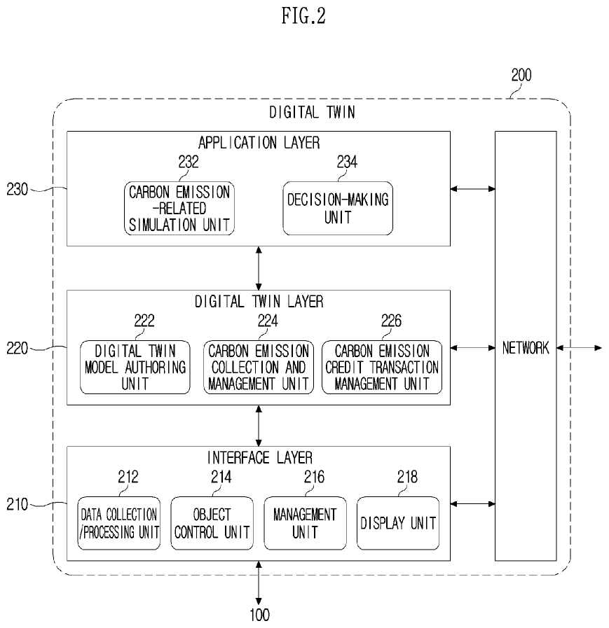

FIG. 2 is a diagram illustrating an example of the configuration of the digital twin shown in FIG. 1.

Referring to FIG. 2, the configuration of a digital twin related to carbon emission management is exemplified. For example, the digital twin configuration shown in FIG. 2 may correspond to a digital twin in each operating entity and/or facility in relation to carbon emission, a digital twin that performs (or supervises) management/transaction of carbon emission (eg, central control digital twin related to carbon emission).

The digital twin 200 may include a digital twin device according to an embodiment of the present disclosure, and may include an interface layer 210, a digital twin layer 220, and an application layer 230.

The interface layer 210 may include a data collection/processing unit 212, an object control unit 214, a management unit 216, and a display unit 218.

The data collection/processing unit 212 may perform a function of receiving and collecting data from the observable object 100. In addition, the data collection/processing unit 212 may perform a function of purifying data such as removing error data from the collected data and matching data units. For example, the data collection/processing unit 212 may perform a function of collecting carbon emission-related information (eg, carbon emission, etc.) calculated in consideration of on-site equipment.

The object control unit 214 may perform a function of transmitting and receiving object control data for controlling the observable object 100.

The management unit 216 may perform a function of identifying and managing the observable object 100 in order to collect data and transmit object control data.

The display unit 218 may perform a function of displaying information related to the domain and/or the observable object 100. For example, the display unit 218 may display the carbon emission status.

The digital twin layer 220 may include a digital twin model authoring unit 222, a carbon emission collection and management unit 224, and a carbon emission credit transaction management unit 226.

The digital twin model authoring unit 222 may be composed of a digital twin visible model authoring technology for expressing the visible characteristics of the observable object 100 and a digital twin dynamic model authoring technology for expressing the dynamic behavioral characteristics of the observable object 100, and may perform the function of modeling to shape the observable object 100 into a virtual digital twin object. In addition, the digital twin model authoring unit 222 includes a simulation function in which the digital twin model generated through authoring technology performs a virtual operation according to changes in input elements.

Digital twin modeling may be the act of digitally generating an expression form for the structure, operation, behavior, current state, and change state of the observable object 100, and the representation of the observable object 100 may be represented in a two-dimensional or three-dimensional form depending on the purpose. The behavioral representation of the observable 100 may be represented in a computer-processable manner, such as mathematical formulas, procedural steps, mandatory and optional options, algorithmic rules, and the like. Since the expression method and precision of motion modeling for the observable object 100 vary depending on the purpose of modeling, the purpose of modeling is first defined, and then the structure, motion, and behavior are modeled. There may be several modeling work methods, and the implementer may selectively adopt an appropriate method to perform it.

For example, by the digital twin model authoring unit 222, digital twin modeling for managing carbon emissions may be implemented in consideration of the structure, operation and characteristics of the operating entity and/or on-site equipment existing in the facility.

The carbon emission collection and management unit 222 may perform a function of collecting and managing carbon emission allowances information related to carbon emission, and a function of collecting and managing carbon emission information in consideration of actual on-site equipment on a digital twin model.

The carbon emission credit transaction management unit 226 may perform a function of collecting and managing information for the price of carbon emission credits on a digital twin model, and trading carbon emission credits.

The application layer 230 may include a carbon emission-related simulation unit 232 and a decision-making unit 234.

The carbon emission-related simulation unit 232 may perform various types of simulations for carbon emission management based on information of the digital twin layer 220.

That is, the carbon emission-related simulation unit 232 may reproduce the past situation based on the information of the digital twin layer 220. In addition, the carbon emission-related simulation unit 232 may monitor a complex situation such as the current location, role, environment, and related laws based on information of the digital twin layer 220. In addition, the carbon emission-related simulation unit 232 may predict a future situation based on information of the digital twin layer 220, and process accordingly.

For example, in the case of a digital twin that manages/transacts carbon emissions, the carbon emission-related simulation unit 232 may perform simulation for comparing the allowed carbon emission with the collected carbon emission (eg, carbon emissions transmitted from a facility's digital twin, taking into account on-site equipment, etc.).

And/or, in the case of a digital twin that manages/transacts carbon emissions, the carbon emission-related simulation unit 232 may perform a simulation for calculating the price of carbon emission credits. In this case, the price of carbon emission credits may be determined/adjusted through simulation in consideration of predicted carbon emissions and carbon emission allowances.

And/or, in the case of a digital twin in each operating entity and/or facility, the carbon emission-related simulation unit 232 may perform a simulation of carbon emission and on-site equipment operation by referring to the collected price of carbon emission credits, etc. Through this, it is possible to determine in advance whether the corresponding carbon emission transaction is optimized in terms of carbon emission and cost, for on-site equipment operation. Here, the on-site equipment may mean equipment existing in each operating entity and/or facility.

The decision-making unit 234 may support decision-making, such as reducing operating costs and improving operational efficiency, based on information of the digital twin layer 220.

As described above, the system/device proposed in the present disclosure may manage carbon emissions by using a digital twin utilized in each domain such as manufacturing, city, home, energy, and medical fields. In addition, carbon emissions may be optimally managed by trading carbon emissions between digital twins so as not to exceed the carbon emission allowances upper limit.

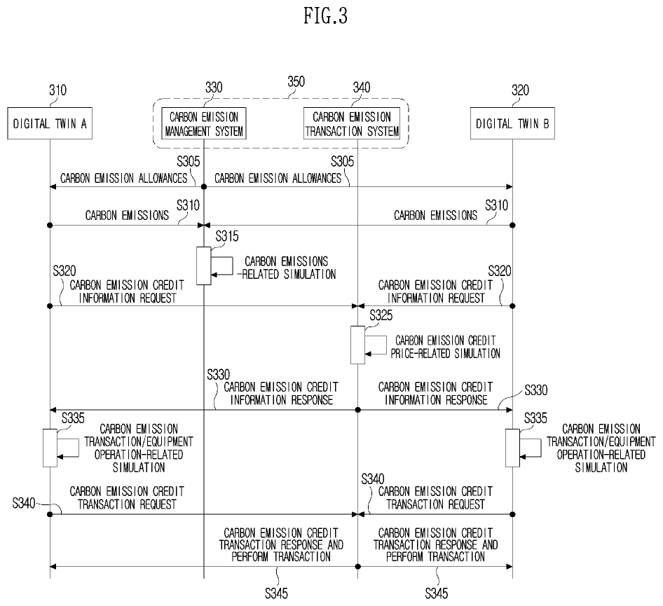

FIG. 3 is a diagram illustrating federation between digital twins for carbon emission management according to an embodiment of the present disclosure.

Referring to FIG. 3, it is assumed that there are a digital twin A 310, a digital twin B 320, a carbon emission management system 330, and a carbon emission transaction system 340.

Here, the digital twin A 310 and the digital twin B 320 may correspond to the digital twin in each operating entity and/or facility described above.

In addition, the carbon emission management system 330 and the carbon emission transaction system 340 may correspond to a digital twin that performs (or supervises) the management/trading of carbon emissions. The carbon emission management system 330 and the carbon emission transaction system 340 may be configured as physically/logically different digital twins, or may be integrated into one digital twin. The carbon emission management system 330 may be integrated into each digital twin A 310 and digital twin B 320, or configured separately to manage carbon emissions in each operating entity and/or facility.

For example, a digital twin for carbon emission central control may include a first digital twin for managing carbon emissions and a second digital twin for trading carbon emission credits. As another example, the digital twin for the carbon emission central control may be a single digital twin designed by integrating the first digital twin for managing carbon emissions and the second digital twin for trading carbon emission credits.

The carbon emission management system 330 may transmit information on carbon emission allowances to the digital twin A 310 and the digital twin B 320 (S305). For example, the carbon emission allowances may be calculated in consideration of policies related to carbon emission.

The digital twin A 310 and the digital twin B 320 may transmit information on carbon emissions to the carbon emission management system 330 (S310). For example, the information on the carbon emissions may include carbon emissions for the operation of on-site equipment for each operating entity and/or facility. That is, the digital twin of each operating entity and/or facility may transmit information on its own carbon emissions to the digital twin that performs the management of carbon emission.

The carbon emission management system 330 may perform a simulation related to carbon emissions based on the received information on the carbon emissions (S315). For example, the carbon emission management system 330 may store information on carbon emissions received/collected for each digital twin of each operating entity and/or facility. Through this, the carbon emission management system 330 may determine the total carbon emissions and may perform a simulation operation of comparing the total carbon emissions with the carbon emission allowances. If the total carbon emissions exceeds the carbon emission allowances, the carbon emission management system 330 may transmit information requesting adjustment/reduction of carbon emissions in the future to the digital twin of each operating entity and/or facility.

The digital twin A 310 and the digital twin B 320 may request information on carbon emission credits to the carbon emission transaction system 340 (S320). For example, the information on the carbon emission credits may include the quantity, unit, price, and the like of carbon emission credits. Here, carbon emission credits may mean costs according to carbon emissions from each operating entity and/or facility.

The carbon emission transaction system 340 may perform a simulation related to the price of the carbon emission credits based on a request for information on the carbon emission credits (S325). For example, the carbon emission transaction system 340 may perform a simulation to determine the optimal price of carbon emission credits predicted/determined to be optimized for carbon emission management, by considering the carbon emission allowances and carbon emissions collected from the digital twin of each operating entity and/or facility (eg, the simulation in S315 step).

The carbon emission transaction system 340 may transmit a response to information on the carbon emission credits to the digital twin A 310 and the digital twin B 320, based on a result of the simulation in step S325 described above (S330). Here, the response to information on the carbon emission credits may include price information on carbon emission credits determined by the result of the simulation in step S325 described above.

The digital twin A 310 and the digital twin B 320 may perform simulation(s) for carbon emission transaction and equipment operation (S335). For example, the digital twin of each operator and/or facility may perform a simulation of carbon emissions and on-site equipment operation based on the received price of the carbon emission credits. That is, each operating entity and/or facility may determine whether the carbon emission transaction and on-site equipment operation are efficient according to the received price of the carbon emission credits.

If it is determined that the price of the carbon emission credits does not optimize the on-site equipment operation, the digital twin of each operating entity and/or facility may transmit information requesting adjustment of the price of the carbon emission credits to the carbon emission transaction system. Then, if adjustment is possible, the carbon emission transaction system may transmit information on the adjusted price of the carbon emission credits to the digital twin of each operating entity and/or facility.

In this way, each operating entity and/or facility may perform optimized on-site equipment operation while meeting the carbon emission allowances.

The digital twin A 310 and the digital twin B 320 may request carbon emission transaction to the carbon emission transaction system 340 (S340). For example, if it is determined that the price of the carbon emission credits is reasonable according to the result of the simulation in step S335 described above, the digital twin of each operating entity and/or facility may request the carbon emission transaction system to proceed with the carbon emission transaction.

The carbon emission transaction system 340 may transmit a response to the carbon emission transaction to the digital twin A 310 and the digital twin B 320, and may perform the carbon emission transaction (S345).

As described above, the method proposed by the present disclosure may manage carbon emissions using a digital twin utilized in each domain such as manufacturing, city, home, energy, and medical fields. In addition, carbon emissions may be optimally managed by trading carbon emissions between digital twins so as not to exceed the carbon emission allowances upper limit.

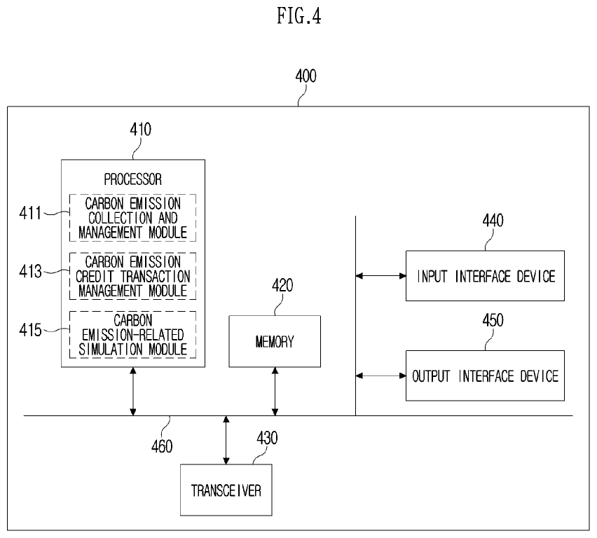

FIG. 4 is a diagram illustrating a digital twin device according to an embodiment of the present disclosure.

Referring to FIG. 4, the digital twin device 400 may represent a computing device in which the above-described digital twin federation-based carbon emission management method is implemented.

For example, with respect to carbon emission management, the digital twin device 400 may correspond of the device configuration for a digital twin in each of the above-described operating entities and/or facilities (eg, digital twin A 310, digital twin B 320 in FIG. 3), and/or a digital twin for performing management/trading of carbon emissions (eg, the carbon emission management system 330, the carbon emission transaction system 340, and the integrated system 350 of FIG. 3).

The digital twin device 400 may include at least one of a processor 410, a memory 420, a transceiver 430, an input interface device 440, and an output interface device 450. Each of the components may be connected by a common bus 460 to communicate with each other. In addition, each of the components may be connected through a separate interface or a separate bus centering on the processor 410 instead of the common bus 460.

The processor 410 may be implemented in various types such as an application processor (AP), a central processing unit (CPU), a graphic processing unit (GPU), etc., and may be any semiconductor device that executes a command stored in the memory 420. The processor 410 may execute a program command stored in the memory 920. The processor 410 may be configured to implement the digital twin federation-based carbon emission management method described based on FIGS. 1 to 3 described above.

For example, the processor 410 may include a carbon emission collection and management module 411, a carbon emission credit transaction management module 413, and a carbon emission-related simulation module 415 as described above in the present disclosure (eg, FIG. 2 described above).

In relation to the method described in FIG. 3, the carbon emission collection and management module 411 may control a function of transmitting and receiving information on carbon emission allowances (eg, operation of step S305) and a function of transmitting and receiving information on carbon emission (eg, operation of step S310), etc.

In addition, the carbon emission credit transaction management module 413 may control a function of transmitting and receiving a request for information on the carbon emission credits (eg, operation of step S320), a function of transmitting and receiving a response for information on the carbon emission credits (eg, operation of step S330), and a function of transmitting and receiving a request for trading the carbon emission credits (eg, operation of step S340) and a function of transmitting and receiving a response for trading the carbon emission credits and performing transaction (eg, operation of step S345), etc.

In addition, the carbon emission-related simulation module 415 may control a function for performing simulations related to carbon emissions (eg, operation of step S315), a function to perform simulations related to a price of carbon emission credits (eg operation of step S325), and a function to perform simulations related to carbon emission transaction and equipment operation (eg, the operation of step S335).

For convenience of explanation, the control functions of the carbon emission collection and management module 411, the carbon emission credit transaction management module 413, and the carbon emission-related simulation module 415 are separately described, but in performing the method described in FIG. 1t goes without saying that interaction between a plurality of modules may be performed.

And/or, the processor 410 may store a program command for implementing at least one function for the corresponding modules in the memory 410 and may control the operation described based on FIGS. 1 to 3 to be performed.

The memory 420 may include various types of volatile or non-volatile storage media. For example, the memory 420 may include read-only memory (ROM) and random access memory (RAM). In an embodiment of the present disclosure, the memory 420 may be located inside or outside the processor 410, and the memory 420 may be connected to the processor 410 through various known means.

The transceiver 430 may perform a function of transmitting and receiving data processed/to be processed by the processor 410 with an external device and/or an external system.

The input interface device 440 is configured to provide data to the processor 410. For example, the input interface device 440 may be configured to provide data (eg, carbon emission related data, etc.) related to an observable object (eg, on-site equipment, etc.) to the processor 410.

The output interface device 450 is configured to output data from the processor 410. For example, the output interface device 450 may be configured to receive carbon emission-related data from the processor 410 and output/display the carbon emission-related status.

Example methods of the present disclosure are expressed as a series of operations for clarity of description, but this is not intended to limit the order in which the steps are performed, and if necessary, each step may be performed simultaneously or in a different order. In order to implement the method according to the present disclosure, other steps may be included in addition to the illustrated steps, other steps may be included except some steps, or additional other steps may be included except some steps.

Various embodiments of the present disclosure do not list all possible combinations but are intended to describe representative aspects of the present disclosure, and matters described in various embodiments may be applied independently or in combination of two or more.

In addition, various embodiments of the present disclosure may be implemented by hardware, firmware, software, or a combination thereof. For implementation by hardware, one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general purpose It may be implemented by a processor (general processor), a controller, a microcontroller, a microprocessor, and the like.

The scope of the present disclosure includes software or machine-executable instructions (eg, operating system, application, firmware, program, etc.) that cause an operation according to the method of various embodiments to be executed on a device or computer, and such software or and non-transitory computer-readable media in which instructions and the like are stored and executed on a device or computer.

What is claimed is:

1. A method of carbon emission management based on a digital twin scheme, the method comprising:
transmitting a request for information on a price of carbon emission credits to a digital twin for carbon emission central control;
receiving a response including information on the price of the carbon emission credits from the digital twin for the carbon emission central control;
performing a simulation for carbon emission transaction and equipment operation based on the received price of the carbon emission credits and a digital twin for equipment operation;
transmitting a request for carbon transaction according to the price of the carbon emission credits to the digital twin for the carbon emission central control, based on a result of the simulation; and
completing the carbon transaction by receiving a response to the request for the carbon transaction from the digital twin for the carbon emission central control.

2. The method of claim 1, further comprising:
receiving information for carbon emission allowances from the digital twin for carbon emission central control; and
transmitting information on carbon emissions related to the equipment operation to the digital twin for the carbon emission central control.

3. The method of claim 2, further comprising:
receiving information requesting a reduction or adjustment of subsequent carbon emissions from the digital twin for carbon emission central control, when the carbon emissions related to the equipment operation exceeds the carbon emission allowances.

4. The method of claim 2,
wherein the price of the carbon emission credits is determined through a simulation based on the carbon emission allowances and carbon emissions collected by a plurality of digital twins designed for each entity of equipment operation.

5. The method of claim 1,
wherein the digital twin for the carbon emission central control includes a first digital twin for managing carbon emissions and a second digital twin for trading carbon emission credits.

6. The method of claim 1,
wherein the digital twin for the carbon emission central control is a single digital twin designed by integrating a first digital twin for managing carbon emissions and a second digital twin for trading carbon emission credits.

7. Apparatus of carbon emission management based on a digital twin scheme, the apparatus comprising:
a processor, a transceiver and a memory for carbon emission management,
wherein the processor comprises a first module to control management of carbon emission credit transaction and a second module to control execution of a simulation related to carbon emissions,
wherein the first module controls to:
transmit a request for information on a price of carbon emission credits to a digital twin for carbon emission central control; and
receive a response including information on the price of the carbon emission credits from the digital twin for the carbon emission central control,
wherein the second module controls to perform a simulation for carbon emissions transaction and equipment operation based on the received price of the carbon emission credits and a digital twin for equipment operation,
wherein the first module further controls to:
transmit a request for carbon transaction according to the price of the carbon emission credits to the digital twin for the carbon emission central control, based on a result of the simulation; and
receive a response to the request for the carbon transaction from the digital twin for the carbon emission central control, and
wherein the carbon transaction is completed based on the reception of the response to the request for the carbon transaction.

8. The apparatus of claim 7,
wherein the processor further comprises a third module to control management and collection of carbon emissions, and
wherein the third module controls to:
receive information for carbon emission allowances from the digital twin for carbon emission central control; and
transmit information on carbon emissions related to the equipment operation to the digital twin for the carbon emission central control.

9. The apparatus of claim 8,
wherein the third module controls to receive information requesting a reduction or adjustment of subsequent carbon emissions from the digital twin for carbon emission central control, when the carbon emissions related to the equipment operation exceeds the carbon emission allowances.

10. The apparatus of claim 8,
wherein the price of the carbon emission credits is determined through a simulation based on the carbon emission allowances and carbon emissions collected by a plurality of digital twins designed for each entity of equipment operation.

11. The apparatus of claim 7,
wherein the digital twin for the carbon emission central control includes a first digital twin for managing carbon emissions and a second digital twin for trading carbon emission credits.

12. The apparatus of claim 7,
wherein the digital twin for the carbon emission central control is a single digital twin designed by integrating a first digital twin for managing carbon emissions and a second digital twin for trading carbon emission credits.

13. Apparatus of carbon emission management based on a digital twin scheme, the apparatus comprising:
a processor, a transceiver and a memory for carbon emission management,
wherein the processor comprises a first module to control management of carbon emission credit transaction and a second module to control execution of a simulation related to carbon emissions,
wherein the first module controls to receive a request for information on a price of carbon emission credits from a plurality of digital twins designed for each entity of equipment operation,
wherein the second module controls to perform a simulation to optimize the price of the carbon emission credits, based on a digital twin for carbon emission central control,
wherein the first module further controls to:
transmit a response including information on the price of the carbon emission credits to the plurality of digital twins, based on a result of the simulation;
receive a request for carbon transaction according to the price of the carbon emission credits from the plurality of digital twins; and
transmit a response to the request for the carbon transaction to the plurality of digital twins, and
wherein the carbon transaction is completed based on the transmission of the response to the request for the carbon transaction.

14. The apparatus of claim 13,
wherein the processor further comprises a third module to control management and collection of carbon emissions, and
wherein the third module controls to:
transmit information for carbon emission allowances to the plurality of digital twins; and
receive information on carbon emissions related to the equipment operation from the plurality of digital twins.

15. The apparatus of claim 14,
wherein the third module controls to transmit information requesting a reduction or adjustment of subsequent carbon emissions to the plurality of digital twins, when the carbon emissions related to the equipment operation exceeds the carbon emission allowances.

16. The apparatus of claim 14,
wherein the price of the carbon emission credits is determined through a simulation based on the carbon emission allowances and carbon emissions collected by a plurality of digital twins designed for each entity of equipment operation.

17. The apparatus of claim 13,
wherein a digital twin for the carbon emission central control includes a first digital twin for managing carbon emissions and a second digital twin for trading carbon emission credits.

18. The apparatus of claim 13,
wherein a digital twin for the carbon emission central control is a single digital twin designed by integrating a first digital twin for managing carbon emissions and a second digital twin for trading carbon emission credits.
